(19) United States
(12) Patent Application Publication
(10) Pub. No.: US 2004/0129639 A1
(43) Pub. Date: Jul. 8, 2004

(54) Extraction methodology for suspended and dissolved material from fruit and vegetable wastewater

(75) Inventors: Stephen D. Allen, Boise, ID (US); Michael R. Rusnack, Star, ID (US)

Correspondence Address: VEDDER PRICE KAUFMAN & KAMMHOLZ, 222 N. LASALLE STREET, CHICAGO, IL, 60601, US

(73) Assignee: Water Solutions, Inc., Sioux Falls, SD

(21) Appl. No.: 10/706,168

(22) Filed: Nov. 12, 2003

Related U.S. Application Data
(60) Provisional application No. 60/425,609, filed on Nov. 12, 2002.

(51) Int. Cl. B01D 61/00; B01D 21/01

(52) U.S. Cl. 210/650; 210/723; 210/732

(57) ABSTRACT

A process is used to remove suspended and dissolved material from fruit and vegetable wastewater. The steps of the process include adding a coagulant polymer to the wastewater. The steps also include the adding of a synthetic organic polymer to the wastewater. During the process, solid particles are produced having a specific definable and controllable size and weight. Another step includes the filtering of the solid particles having a specific definable and controllable size and weight from the wastewater. Additionally, a product for consumption by animals is rendered from the solid particles.

### CROSS-REFERENCE TO RELATED APPLICATIONS

This application claims the benefit of U.S. Provisional Application Ser. No. 60/425,609, filed Nov. 12, 2002, entitled “Wastewater Treatment of Liquid and Solid Waste from Cold Process Carrot Plants”, having as inventor Stephen Donald Allen.

### FIELD OF THE INVENTION

The present invention relates generally to a process of removing suspended and dissolved material from wastewater. More particularly, the present invention relates to a process of removing a variety of suspended and dissolved solids from fruit and vegetable wastewater by adding a mixture of compounds to the wastewater and subsequently filtering out solid particles.

### BACKGROUND OF THE INVENTION

Other systems and processes exist for removing material contained within in a liquid. In one system, a combination of compounds are added to an aqueous solution for the purpose of reducing its turbidity. The compounds added include aluminum chlorohydrate and at least one water-soluble cationic polymer including polyamines. A preferred polyamine in such system is epichlorohydrin-dimethylamine (eip-dma). The effective amounts of the compounds are those amounts necessary to reduce the turbidity. The mixing of the compounds result in the settling of fine suspended matter from the aqueous system. Here, retention time is required for settling. Examples of the system use a measure of the final turbidity of the aqueous liquid, as measured in nephelometric turbidity units (NTUs), to determine its effectiveness.

In another system, also again directed to reducing turbidity, a combination of chemicals are added to raw waters. The combination of chemicals is used to introduce liquid-solid separation. Such solids are separated removed by settling heavier solids and/or by floating lighter solids where such lighter solids may be skimmed or filtered away. Here, retention time is required for settling and/or floating. Examples of such systems are evaluated upon the amount of measured turbidity (i.e., NTUs) in the resulting processed waters. In one example, aluminum chlorohydrate and low molecular weight eip-dma are used together to achieve a final water product having less than 0.3 NTU.

Another system discloses the precipitation of suspended particles and components including suspended starch, other carbohydrate or sugar units containing organic particles and other suspended solids from a solution. The system uses a complexing agent, such as multivalent metal ions and their complexes, along with a flocculating agent where flocculating agents are said to include large synthetic polymers such as polyacrylamides, polycarboxylates and polyamines. The complexing agents first associate with organic particles and components. Next the flocculating agent interacts with the complexing agents to produce large, neutral and substantially organic complexes that is insoluble in the solution. Conventional filtration techniques are used to collect the suspended solids. The system is claimed to reduce COD (chemical oxygen demand)/BOD (biochemical oxygen demand) content. In a series of examples of the systems operation, some including the heating of the water, the success of the examples was measured in the reduction of COD.

### SUMMARY OF THE INVENTION

Briefly, a process is used to remove suspended and dissolved material from fruit and vegetable wastewater. The steps of the process include adding a coagulant polymer to the wastewater. The steps also include the adding of a synthetic organic polymer to the wastewater. During the process, solid particles are produced having a specific definable and controllable size and weight. Another step includes the filtering of the solid particles having a specific definable and controllable size and weight from the wastewater.

### BRIEF DESCRIPTION THE DRAWINGS

The invention will be more readily understood with reference to the following drawings wherein like reference numbers represent like elements and wherein:

FIG. 1 is schematic view of a system for removing suspended and dissolved material from fruit and vegetable wastewater, in accordance with one embodiment of the invention;

FIG. 2 is schematic view of a micro-filtration tank used in the system for removing suspended and dissolved material from fruit and vegetable wastewater, in accordance with one embodiment of the invention;

FIG. 3 is a table containing sample readings recorded during six days of operation of the production scale example, in accordance with one embodiment of the invention;

FIG. 4 is a table containing sample readings recorded during six days of operation of the production scale example, in accordance with one embodiment of the invention;

FIG. 5 is a table containing sample readings recorded during a two week period of operation of the production scale example, in accordance with one embodiment of the invention;

FIG. 6 is a table containing sample readings recorded during a two week period of operation of the production scale example, in accordance with one embodiment of the invention;

FIG. 7 is a table containing sample readings recorded during a two week period of operation of the production scale example, in accordance with one embodiment of the invention; and

FIG. 8 is a table containing sample readings recorded during a two week period of operation of the production scale example, in accordance with one embodiment of the invention.

### DETAILED DESCRIPTION OF THE INVENTION

Some embodiments described herein concern the wastewater treatment of liquid and solid waste from cold process carrot plants. Such embodiments describe the process for removing solid waste (TSS or total suspended solids) from the wastewater (liquid) fraction and the subsequent further processing of the resulting liquid to meet or exceed potable grade (Environmental Protection Agency (EPA) definition of) or canal category 1 water (State of California Water Board definition). For example, the chemicals used in the lab and production scale examples discussed below, were each EPA drinking water registered, nonhazardous, nontoxic and used in low concentration. In addition to the water purification, some embodiments also include the concentrating of solid waste and the potential for reuse as feed to the nutriceutical industry or for feed additives to the poultry, cattle, hog or other industries. In some such embodiments we are able to attain 22-26% solid matter with protein at 50+% levels for rendering and are also able to attain a pH in the acceptable range of 6-8.

Described below are two examples of the process described above. One example, the lab scale example, represents the implementation of the process at a lab level. Here, the process was examined at the lab level with lab quantities, lab equipment and other lab scale circumstances and results. The other example, the production scale example, represents the implementation of the process at a production level. Here, the process was examined in a production environment with production quantities, production equipment and other production scale circumstances and results. The lab scale example typically represents a small scale embodiment of the invention while the production scale example represents a large scale embodiment of the invention.

Lab Scale Example

In a small scale example, the lab scale example, process liquid from a carrot plant in Bakersfield, Calif., was treated in a laboratory in Caldwell, Id. The lab scale example was performed by processing five gallons of wastewater. The influent, effluent and reduction percent were as follows:

| COMPONENT | INFLUENT | EFFLUENT | REDUCTION % |
|---|---|---|---|
| BOD | 1690 | <2 | >99% |
| TSS | 765 | <2 | >99% |
| TDS | 1,580 | 1,550 | 2% |

The reactions were carried out under the following conditions: all materials were kept at 4 degrees centigrade until ready for use, and were utilized not more than three days after receipt. Containers were shaken vigorously prior to use and the materials were all made up the morning of the test work. The chemicals used for the reactions were as follows:

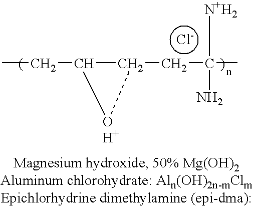

Mg(OH)₂ was optionally used to adjust the pH of the wastewater, if required. The pH of the influent material from the waste stream was measured at pH=6.5+/−0.2 and was quite stable. If pH adjustment is used, any normally accepted pH adjuster would be acceptable, but, in this example, pH adjustment was not really needed for the reaction to proceed. In addition, it is foreseen that additional treatment of the effluent under slightly acidic conditions would likely be preferable, including: reverse osmosis, ultrafiltration, nanofiltration or other suitable treatments. In this embodiment, if pH adjustment is performed, it should ideally occur before the addition of the primary coagulant. Some solids showed formation as the pH rises above the 7.4 level, presumably, the TDS (total dissolved solids) contains some sulfates which will precipitate as Mg(SO₄)₂. This is to be expected and is normal.

The addition of the aluminum chlorohydrate, Alₙ(OH)₂ₙ₋ₘClₘ, commonly referred to as ACH, a coagulation polymer, is to coagulate the solids into a slightly larger (microscopic to macroscopic) particle. The use of aluminum chlorohydrate as a coagulant is further described for an entirely different application, for example, in co-pending application entitled “WASTE WATER TREATMENT PROCESS AND APPARATUS FOR ANIMAL PROCESSING CONTAMINANT REMOVAL,” having inventor Stephen Allen, filed on Apr. 4, 2002, having Ser. No. 10/115,821, incorporated by reference in its entirety herein. The average particle size was 15 microns (u). Reaction time was approximately 5 minutes to generate a uniform particle size. Any of the so-called coagulants would probably work here, with the exception that nonpolymeric aluminum based coagulants would create larger, much less uniform particles than the polymeric based aluminum coagulants. Also, any of the ferric (iron) based coagulants would accomplish the same objective with the same caveats as discussed above. This is the reaction to charge neutralize the particles (+charge)+(−charge)=0. This is also referred to as charged particle interaction.

The final addition of the epi-dma, a synthetic organic polymer, (neutralizer polymer), is to join the particles to an organic polymeric backbone of known molecular size. This process is also referred to as particle neutralization. The epi-dma used in our experiments had a molecular weight of 240,000 atomic mass units with known potential uptake of the charge neutralized particles. We believe that if other polymers of general description, such as diallyldimethyl ammonium chloride (DADMACs) or other quaternary polymers were used, the same level of reaction would be seen. We studiously stayed away from the high molecular weight acrylamides, both anionic and cationic, as we chose to use the lower molecular weight epi-dmas (150,000-500,000) due primarily to the membranes employed, polyacrylates, 2.0 micron. In the past we have seen some serious adhesion of the reacted solids to the surface of the membrane and such adhesion is contrary to the purpose of this invention. As reflected in our testing, the higher (or lower) the molecular weight, the larger (or smaller) the particles, and the size of the generated polymer is dependent strictly on the binding sites of the polymer. This relationship is what allows the specific determination and formation of a particular particle size.

In this example, we looked at 2 membranes for the final separation of the liquid and solid phase of the treated wastewater. The results, shown in the table above, reflect the separation of the two phases in the best of the forms tested. We tried the 2.0 micron polyacrylate and the 1.0 micron polyacrylate. The results shown were from the 2.0 micron final filtration from the reaction described as above, with no pH adjustment by Mg(OH)₂. There did not appear to be any specific slowing of the filtrate from the 1.0 micron polyacrylate membrane, but no specific numbers were generated to confirm the speed or the efficiency of the flow through the membrane.

All reactions were carried out at room temperature, standard pressure and under normal laboratory conditions. To a 500 ml beaker with constant stirring was added 450 ml+/−wastewater. To the beaker was then added 100 micro liters of a 50% solution of ACH, with constant mechanical stirring for 5 minutes. To this we then added 50 micro liters of a 20% solution of epi-dma again with constant mechanical stirring for 5 minutes. This beaker of now reacted wastewater was then allowed to sit for 5 additional minutes for settling of the solids from the liquid solid separation.

The water was decanted out of the beaker over the 2.0 micron polyacrylate membrane (filter membrane) and allowed to either decant by gravity or be processed by 0.25 torr (vacuum) pulling through the membrane. There was no noticeable or obvious delay in the movement of the clean water fraction through the membrane. We saw under microscopic evaluation no solids remaining on the surface of the membrane and no stoppage or slowing of flow over repeated tests of the same as described above.

In one embodiment the water that was filtered through the filter membrane met and exceeded the potable grade (EPA definition as defined under the Federal Water Pollution Control Act, Title 33, Chapter 26, United States Code) or canal category 1 water (State of California Water Board definition under the provisions of the California Water Code (CWC)). In one embodiment the solids collected on the filter membrane was of a form that was capable of reuse as feed to the nutriceutical industry or for feed additives to the poultry, cattle, hog or other industries.

Production Scale Example

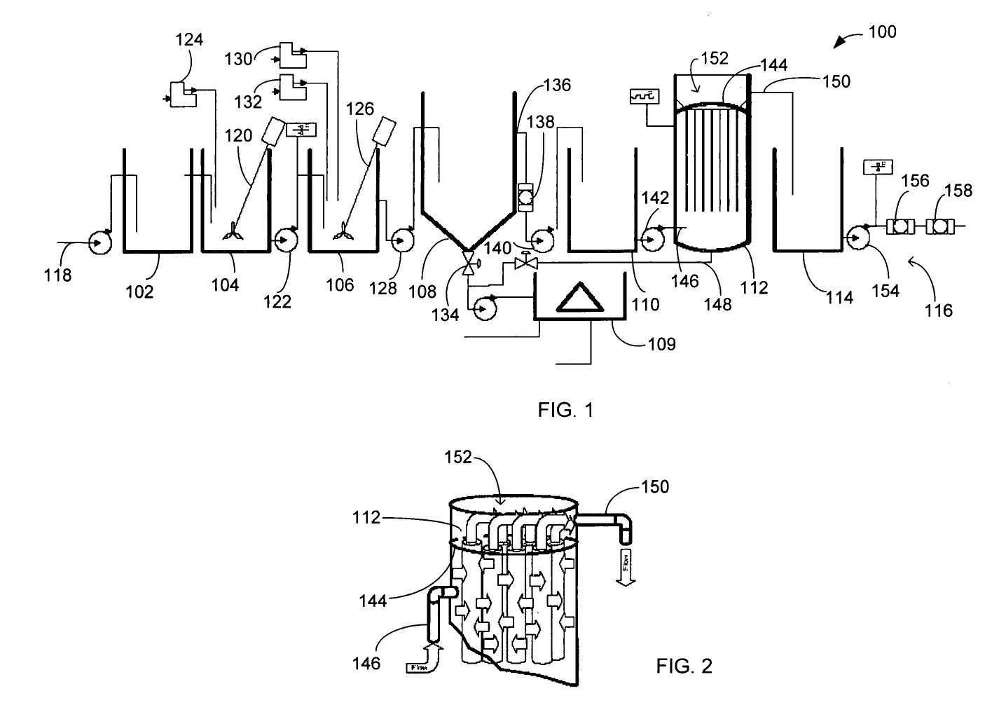

FIG. 1 shows a large scale example, the production scale example, representing another embodiment of the invention, where a continuous process was used to process wastewater from a fruit and vegetable processes. The plant scale example operated continuously for several days and processed 2-5 gallons per minute (gpm) for hours at a run. Ultimately, a rate of 2.5 gpm was selected as an optimal rate. The production scale testing lasted over a two week period and approximately 1,000 gallons per day (gpd) were processed.

The fruit and vegetable wastewater treatment system 100 is further shown to include a raw wastewater tank 102, a pH adjuster tank 104, a solid particle building tank 106, a solid particle separation tank 108, a solids collections tank 109, a treated liquid holding tank 110, a micro-filtration tank 112, a final holding tank 114 and a filtration system 116. The tanks generally used in this production scale example had a total capacity of 100 gallons, although on average, only 50 gallons of such capacity was used. Further, the process operated such that 2.5 gpm was transferred from one tank to another, and therefore, the total transfer of the contents from one tank to the next took approximately 20 minutes. As a whole, once the process started, several hours passed from the time the initial wastewater (influent) entered the system and the first processed liquid (effluent) left the system. Once the tanks were filled, the system operated in a continuous processing mode, and as such, is capable of running indefinitely.

Raw wastewater tank 102 received wastewater continually from a common sump 118. The common sump 118 contained the confluence of all plant wastewater streams including, in this example, the wash water from a peach and tomato plume and from a caustic peel and process. In this example a submersible pump was used to pump the wastewater from the common sump to the raw wastewater tank 102 which acts as a buffer or holding tank for the fruit and vegetable wastewater treatment system 100. The capacity of the raw wastewater tank allowed the process to be stopped or slowed without affecting the influent stream. As the raw wastewater tank filled to 65% of capacity, the wastewater to be treated spilled over into the pH adjuster tank 104.

The pH adjuster tank 104 contained a pH adjuster tank mixer device 120, a pH adjuster tank pump 122 and also received output of a pH adjuster pump 124. The pH adjuster tank mixer device 120 was started when the incoming wastewater from the raw wastewater tank 102 filled the pH adjuster tank 104 to a 25% capacity. The pH adjuster pump 124, when used, provided a pH adjuster to the contents of the pH adjuster tank 104. The pH adjuster was added to adjust the pH and to remove any sulfates and other dissolved solids present in the wastewater. Generally, pH levels above 4.5 would constitute an effect pH level. In this example the type of pH adjuster added was Mg(O) (resulting in the formation of Mg(OH)₂). Other types of pH adjusters include: sodium hydroxide (NaOH), lime (Ca[O], potassium hydroxide (KOH), sulfuric acid (H₂SO₄), hydrochloric acid (HCl), etc. The amount of Mg(O) added to the wastewater was based upon the percentage of sulfate TDS in the wastewater and was used to transform the TDS to TSS. Typically the amount added is in a 1:1 mole ratio, although other ratios are possible. The amount added in this example was less than 20 ppm.

Although some of the testing of production scale example included the use of a pH adjuster as described above, such was provided because its use was part of a control in the experiments. However, additional testing here did not include the use of such a pH adjuster as the pH of the influent determined to be too high for the addition of Mg(O). As observed, when the pH adjuster was not added, no adverse impact occurred as compared to when pH adjuster was added.

When the contents of the pH adjuster tank 104 reached 50% capacity, the pH adjuster pump 124 was started such that the pH adjuster was added to the contents of the pH adjuster tank 104. When the pH adjuster tank 104 reached 75% of capacity, the pH adjuster tank pump 122 was started and the pump began pumping the contents of the pH adjuster tank 104 to the solid particle building tank 106.

The solid particle building tank 106 contained a solid particle building tank mixer device 126, a solid particle building tank pump 128 and also received output from both a coagulation polymer pump 130 and a synthetic organic polymer pump 132. A constant rate of flow was maintained by balancing the rate of flow from the pH adjuster tank 104 and the solid particle building tank 106. The solid particle building tank mixer device 126 was started when the incoming wastewater from the pH adjuster tank 104 filled the solid particle building tank 106 to 25% capacity. At the same time, both the second and synthetic organic polymer pumps 130 and 132 were activated.

The coagulation polymer pump 130 provided a polymer (a coagulant polymer) capable of neutralizing the suspended and dissolved material into coagulated solid particles. The coagulant polymers include aluminum or iron based compounds having a charge of +3 or other suitable calcium compounds or other suitable compounds. Examples of such aluminum compounds include aluminum chloride, aluminum sulfate, poly aluminum chloride, calcium aluminate, sodium aluminate and aluminum chlorohydrate and other suitable aluminum based compounds. Examples of such iron based compounds include ferric sulfate or ferric chloride. In one embodiment, calcium aluminate, with the Al as+3, is used where the calcium acts primarily as a pH adjustment. The production scale example used aluminum chlorohydrate. The compound selected as the coagulant polymer was generally based on its charge and the pH of the wastewater. If the pH was low, a basic compound was added, and if the pH was high, an acid compound was added.

The amount of coagulant polymer added depended upon the amount of TSS, BOD and COD that was present in the wastewater. For example, the amount of coagulant polymer (in parts per million), and representing a nominal amount of coagulant polymer, was calculated as follows: 20*((BOD Qty+COD Qty+(0.35*(TSS Qty)))/1000) where the BOD Qty, COD Qty and TSS Qty represent the corresponding amounts of BOD, COD and TSS in the wastewater. Further, applying such formula to the following measured amounts: BOD Qty=2930; COD Qty=4192; AND TSS Qty=7800, yields approximately 200 ppm. This calculation represents a starting point, and as such, was adjusted as needed to produce a more productive result. The coagulant polymer was added to associate with the BOD and TSS to form a solid having a controlled size. The amount of coagulant polymer used was based on where the BOD and COD was located. If it was in the suspended solids, the coagulant polymer was added to collect the suspended material. The amount of coagulant polymer used ranged from 50 to 200 ppm, and was provided in a 30-50% solution.

The third pump 132 provided a controlled mole weight cation, (an organic polymeric backbone of known molecular size and weight), (a synthetic organic polymer), such as DADMAC, acrylamide, epi-dma or other suitable compound to produce a solid particle having a specific definable and controllable size and weight. The production scale example used epi-dma having a molecular weight of 240,000. The amount of synthetic organic polymer added was based on a ratio to the amount of coagulant polymer used. Ideally the ratio of coagulant polymer to synthetic organic polymer is 13:1. However, such a ratio was based upon the assumption that the coagulant polymer represents the only charged materials suspended in the wastewater. In operation, other charged materials are also often suspended in the wastewater, and therefore, a typical operational amount of synthetic organic polymer, and representing a nominal amount of synthetic organic polymer, is at a ratio of coagulant polymer to synthetic organic polymer of somewhere between 20:1 and 25:1. This ratio represents a starting point, and as such, was adjusted as needed to produce a more productive result. Further, different embodiments utilize ratio ranges of coagulant polymer to synthetic organic polymer from 5:1 to 25:1. The amount of synthetic organic polymer used ranged from 10 to 50 ppm. Further, the synthetic organic polymer is typically added to the wastewater in a 20-30% solution.

Regarding particle size achieved from the mixing of the coagulant polymer and the synthetic organic polymer, in one embodiment the optimum size is around 35 microns, the minimum is 15 microns and the maximum is as large as 150 microns. In other embodiments the maximum particle size above 150 microns, but such particle size is not much more than that.

In another embodiment the coagulant polymer and the synthetic organic polymer can be added sequentially rather than simultaneously. Regardless of order of addition, the coagulant polymer gathers the suspended and dissolved material in the wastewater via charge interaction and produces a coagulated solid particle, while the synthetic organic polymer completes the solid particle formation via neutralization and produces a final solid particle generally having a specific definable and controllable size and weight. The liquid that remains after the forming of the final solid particle is referred to here as the treated liquid. The mixture of both the treated liquid, and the solid particles having a specific definable and controllable size and weight, is together referred to here as the treated solution.

In the production scale example, a sample of the liquid was taken from the solid particle building tank 106, anywhere between 15 and 45 minutes from the time that the coagulant polymer and the synthetic organic polymer were initially added to the solid particle building tank 106, and revealed a transparent liquid with noticeably visible particles floating and then very quickly settling to the bottom.

Dwell time is length of time that a solid is allowed to form, i.e., the time that the wastewater is exposed to the coagulation and/or synthetic organic polymers. Dwell time is easily calculated by the flow rate into a tank and the size of the tank. For example, 2 gpm into a fifty-gallon tank is a twenty-five minute dwell time. That is, the tank will begin to overflow to the next in 25 minutes when delivered 2 gpm. This is important to understand for optimal system operation. If the dwell time is too short the particle formation may be incomplete and may not settle properly. If the dwell time is too long, although the formation of solid particles is not affected, system efficiency is harmed. In the production scale example the initial dwell time was set at thirty (30) minutes.

However, by adjusting the dwell time it was determined that dwell times of minutes to hours had no adverse effect on the solid particles formed. In other words, within minutes, substantial association had occurred, and within hours, little to no dissociation was present. More specifically, at 2 minutes, the general distribution of the solid particles was present, however there was wide distribution of the solid particle sizes in the formation. Most notably present was the formation of smaller solid particles and the incomplete formation and collapse of larger solid particles to the nominal distribution of solid particles in the 50 micron range. A preferred dwell time is one that allows for the building of solid particles with a relative tight distribution of solid particle size. The tighter the distribution (consistent solid particle size) allows for the greatest efficiency in many aspects of the overall process including the removal of that solid particle and the contaminant associated with it. In one embodiment the range in particle size is in the 30-75 micron (μ) range. In another embodiment the particle size is in the 35μ range+/−10μ with about a 3 sigma (σ) variation. As the operational scale example was a continuous operation system, the dwell time or retention time was particularly important to manage. By aggressively mixing the polymers with the wastewater, the dwell time can be minimized. Dwell times of 5 to 30 minutes were found to produce operationally workable results. However, after exploring different dwell times, a dwell time of 15 minutes was chosen as optimal when considering solid particle formation and flow rates of the system.

In a dose response test, the amount of coagulant polymer used in the process was varied from nominal, i.e., the amount determined from the calculation above. The dose response test was used to determine the effect of the volume of the coagulation and synthetic organic polymers added in relation to the solid particles built. The test procedure was performed as follows: first, at the nominal setting of both the coagulation polymer and the synthetic organic polymer, a liquid sample was removed from the solid particle building tank 106. A 500 ml Erlenmeyer flask was used to remove the liquid. The flask was placed on a level surface, immediately the particles began to settle. After two minutes, the flask was marked at the level at which the particles had settled or compacted.

The process was then repeated for settings of 50%, 75%, 125%, and 150% of the coagulation polymer while the synthetic organic polymer remained at its nominal setting. It was important to allow the system to stabilize to fully ensure the effect of the chemistry was fully realized. The stabilization time was found to increase up to one hour when the amount of coagulation polymer was increased, and was found to decrease up to four hours when the amount of coagulation polymer decreased. When a reduced rate of coagulation polymer was tested, such process was started at the reduce rate.

After performing the test at each of the settings it was determined that the nominal setting (see formula above) for the coagulation polymer produced the best results. Although the settling rate appeared to be slightly better when less coagulant polymer was used, the flocculated material appeared to be very light and wispy and easily disrupted. Based on these test, it was determined that the initial setting of the coagulation polymer amount was optimal. This nominal setting was calculated based on the earlier lab scale example discussed above. The results of the test showed that if too little coagulation polymer is added, the particle formation is slow and ineffectual, and if too much coagulation polymer is added, the operational cost of the system increases.

The same steps were repeated for the synthetic organic polymer. As soon as the amount of the synthetic organic polymer was increased the system was observed to become immediately unstable. The solid particle formed failed to settle even after extensive dwell time and even after an increase in the amount of coagulation polymer. As a result of this and other testing, the nominal settings for both the neutralizing and coagulant polymer were determined to be the optimal settings.

When the solid particle building tank 106 reached 75% capacity the solid particle building tank pump 128 was started and the contents of the solid particle building tank 106, the treated solution, was pumped into the solid particle separation tank 108. The rate of pumping from the solid particle building tank 106 was balanced with the pumping into the solid particle building tank 106 from the pH adjuster tank 104.

The solid particle separation tank 108 contained a solids dispensing mechanism 134, located at its bottom, and a liquid dispensing mechanism 136 located near its top. As the treated solution was pumped into the solid particle separation tank 108 from the solid particle building tank 106, a settling process occurred where the solids settled to the bottom of the solid particle separation tank 108 and a clear treated liquid (containing residual solid particles that did not settle) remained in the remaining portion of the tank. The liquid dispensing mechanism 136, further included a carbon filter 138 and a clear liquid pump 140, the clear liquid pump pumped the clear liquid contents of the solid particle separation tank 108 through the carbon filter 138 and into the treated liquid holding tank 110. The solids dispensing mechanism 134 was used to remove the solids that settled to the bottom of the tank. In one embodiment, such solid material was collected and retained for subsequent lycopene extraction.

The solids collection tank 109, which had a collection tank pump 140, received the solids from the solid particle separation tank 108 as it was pumped from the collection tank pump 140. Once received in the collection tank pump 140, the solids were further processed via either a centrifuge or filter press to remove remaining liquid therein. Any remaining liquid retrieved from this process was redirected to the raw wastewater tank 102 for reprocessing.

The treated liquid holding tank 110 received treated liquid from the liquid dispensing mechanism 136. The treated liquid holding tank 110 had a treated liquid holding tank pump 142 for transferring its treated liquid contents to the micro-filtration tank 112. The contents of the treated liquid holding tank 110 was pumped into the micro-filtration tank 112 when the treated liquid holding tank 110 reached 75% capacity.

The micro-filtration tank 112 contained a filter membrane 144, a lower input micro-filtration tank passageway 146, a lower output micro-filtration tank passageway 148, an upper output micro-filtration tank passageway 150 and an upper reservoir 152. The properties of the filter membrane 144 affected its operation in conjunction with the system. For example, a polypropylene filter membrane 144 is particularly well suited for handling high pH solutions and was used in this example. In addition, pore size can be a factor that influences filtration efficiency and contaminant removal. It is important to balance the flow-rate (GFD—gallons per square foot per day) of the membrane with the amount of solid materials to be collected on the membrane surface. The greater amount of material collected on the surface of the membrane, the more often the system must be shut down and the membrane cleaning process (particle release) must be performed. The micro-filtration tank 112 was designed to allow the easy interchange of the filter membranes, thus allowing for the exchange of a membrane of one particular micron size to another membrane of another particular micron size.

In the production scale example, both 10 micron (the initial setting) and 1 micron sized filter membranes 144 were utilized. However, a membrane range of at least 0.7 microns to 20 microns may also be used. A 20 micron filter membrane 144 is less desirable as it allows particles smaller than 20 microns in size to pass through the filter. Where a 0.7 micron filter membrane 144 is used a modification may be required to the system to accommodate what may be a restricted flow through such membrane. At some point there likely exists a trade-off between pore size and flow rate. Optimally, to capture the most particles, a small pore size is sought, however a reduced flow rate may require the use of a larger pore size. In the production example, the pore size of 1 micron was preferred.

In the production scale example, the change from a 10 micron filter membrane 144 to a 1 micron filter membrane 144 (while maintaining the other system parameters in their initial setting) did not produce a perceivable difference on the flow rate or the overall system performance. Accordingly, no pressure increase (discussed below) was detected in the micro-filtration tank 112 as a result of the change. Based on the resulting flow through the micro-filtration tank 112, it was determined that the flow capacity of the 1 micron membrane to be 801 GFD.

As arranged, the flow through the filter membrane 144 in the micro-filtration tank 112 was from the outside of the membrane to the inside of the membrane. This process allowed the solid material (including residual solid particles) to collect on the outer surface of the filter membrane 144. As such, the filter membrane 144 easily released the collected solid material. Specifically, in operation, the flow to the micro-filtration tank 112 was halted. The flow of the water through the micro-filtration tank 112 was reversed by opening a valve in the bottom of the micro-filtration tank 112. This was accomplished with the assistance of the collection tank pump 140, and pipes connecting the valve from the bottom of the micro-filtration tank 112 to such pump, where the collection tank pump introduced an abrupt change in pressure causing the membranes to be shocked such that the collected particles (solids) fell to the bottom for removal to the solids collection tank 109 for subsequent filtering or centrifugation. During normal filtering operations, liquid, having passed through the filter membrane 144, and into the upper reservoir 152, overflowed through the upper output micro-filtration tank passageway 150 into the final holding tank 114.

During operations a pressure existed in the micro-filtration tank 112. The amount of pressure was dependent upon two different factors: particle collection and membrane fouling. As observed, the production scale embodiment did not produce a measurable pressure drop across the filter membrane. As such, the material selection and porosity of the filter membrane 144 was considered suitable for this application.

Particle collection refers to the accumulation of solid particles (including residual solid particles) on the filter membrane 144 during the filtration process. The porosity of the filter membrane 144 determines the pressure that is necessary to force the processed water through the filter membranes 144. During typical operation, solid particles are collected on the surface of the filter membrane 144. Unlike other chemical filtration systems, as the solids collected, the filtration efficiency was observed to increase while at the same time the flow rate through the filter membrane 144 changed very little. In at least one embodiment, we were able to maintain a relatively constant flow of liquid based on our ability to make the particle nontacky and conformational in shape.

Here, because of the common and consistent molecular size of the solid particles, such solid particles accumulated in a stacking fashion such that liquid could to pass through the areas in between such commonly sized solid particles. For example, such particles having a common size stack up like marbles where the spaces around the marbles allow significant liquid flow therethrough. As a result, the outer border of the accumulating solid particles acted as a continuously growing filter that both filtered out additional solid particles while allowing liquid to pass where the overall rate remained substantially constant. As described, the common and consistent molecular size of the solid particles provides the advantage of allowing filtration to proceed for extended periods of time while both increasing filtration efficiency and avoiding significant flow rate loss.

In one embodiment, pressure on the filter membrane 144 is monitored such that when a specific pressure is reached, for example, 12 pounds per square inch (psi), a dump of the solids from the filter membrane 144 is then invoked. One difference between this embodiment and the prior art systems is the filtering performed yields solids that are very dry as compared to normal solids. More specifically, the solids collected contain less than 3% “bound” water, in comparison, natural carrots or tomatoes generally come out of the ground having 25% solid and 75% water. In one embodiment, the solids collected show 25% solids and 75% water and the water is pretty much unbound.

Membrane fouling refers to the degradation of the filter membrane 144 after repeated use. Periodically the solids amassed on the surface of the filter membrane 144 are released and collected as described above. The solids generated by the process are typically non-tacky, and thus do not foul the filter membrane 144 as typically occurs during other “chemical—membrane” applications. After repeated cycles of collection and release, the filter membrane 144 continued to perform at approximately 99% (flow rate) of its initial capacity.

The final holding tank 114 contained a final holding tank pump 154 connected to its bottom. Once enough liquid filled the final holding tank 114, the contents were then pumped through filtration system 116. In this example, the filtration system 116 included a five-micron micro filter 156 and a carbon column filter 158. This operation represents the final effluent for this process.

FIG. 2 shows, and which is further discussed above with regard to FIG. 1, a more detailed rendering of the micro-filtration tank 112. The micro-filtration tank 112 shows a filter membrane 144, a lower input micro-filtration tank passageway 146, a lower output micro-filtration tank passageway 148, an upper output micro-filtration tank passageway 150 and an upper reservoir 152. As shown, membranes arranged in a tubular layout are connected to the upper reservoir 152 such that the treated wastewater penetrates the outside of the filter membrane 144 into the inside tube formed within the filter membrane 144 and travels upward into the upper reservoir 152 to be expelled through the upper output micro-filtration tank passageway 150.

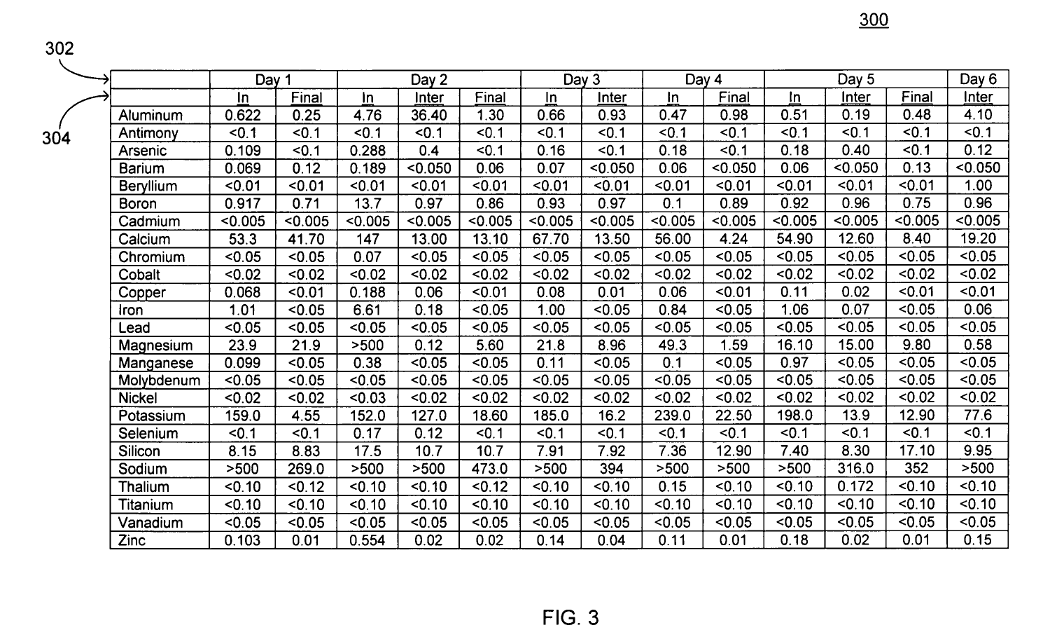

As recorded in FIG. 3, during six days of the operation of the production scale example, samples were taken in three different places along the wastewater treatment system 100. An influent location (In) was placed at the common sump 118 where materials were retrieved before the addition of any chemicals. Next, an intermediate location (Inter) was placed at the treated liquid holding tank 110. Finally, a third, and final location (Final) was placed at the end of the filtration system 116 where the final effluent of the system was discharged from the fruit and vegetable wastewater treatment system 100.

Table 300 of FIG. 3 indicates, in its columns and rows, the information recorded from each of the samples. The first row 302 indicates which day of testing of the sample was taken. The next row 304, indicates which location the sample was taken at. The remaining rows identify particular elements being sampled and their corresponding measured amounts recorded the day and at the location indicated by the information listed in the first and second rows 302 and 304.

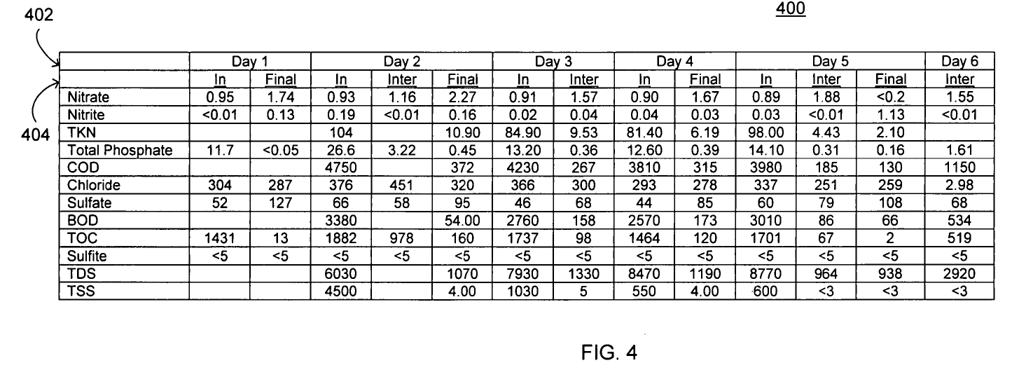

FIG. 4 has additional recorded samples from the six days of the operation of the production scale example. The locations of the measurements from FIG. 4 are the same as those discussed above with regard to FIG. 3. As such, table 400 of FIG. 4 indicates, in its columns and rows, the information recorded from each of the samples. The first row 402 indicates which day of testing of the sample was taken. The next row 404, indicates which location the sample was taken at. The remaining rows identify particular material being sampled and their corresponding measured amounts recorded the day and at the location indicated by the information listed in the first and second rows 402 and 404.

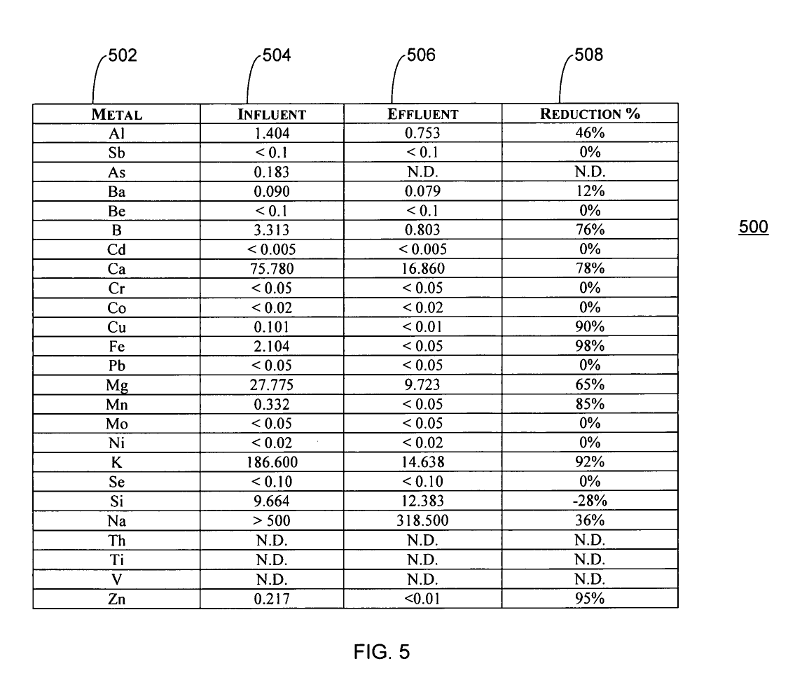

FIG. 5 is a table 500 storing recorded readings of particular metals in both the influent and the effluent of water treatment system 100. In addition, a percentage reduction is also included in such table. The first column 502 lists the metals that were tested for. The second column 504 lists the corresponding level of the particular metal (by row) as measured in the influent of the system. The third column 506 lists the corresponding level of the particular metal as measured in the effluent of the system. Finally, the forth column 508 contains the corresponding reduction percentage in the corresponding metal (by row) as recorded between the influent and effluent of the system. The recorded readings populating the table represent mean average values measured over a two week period.

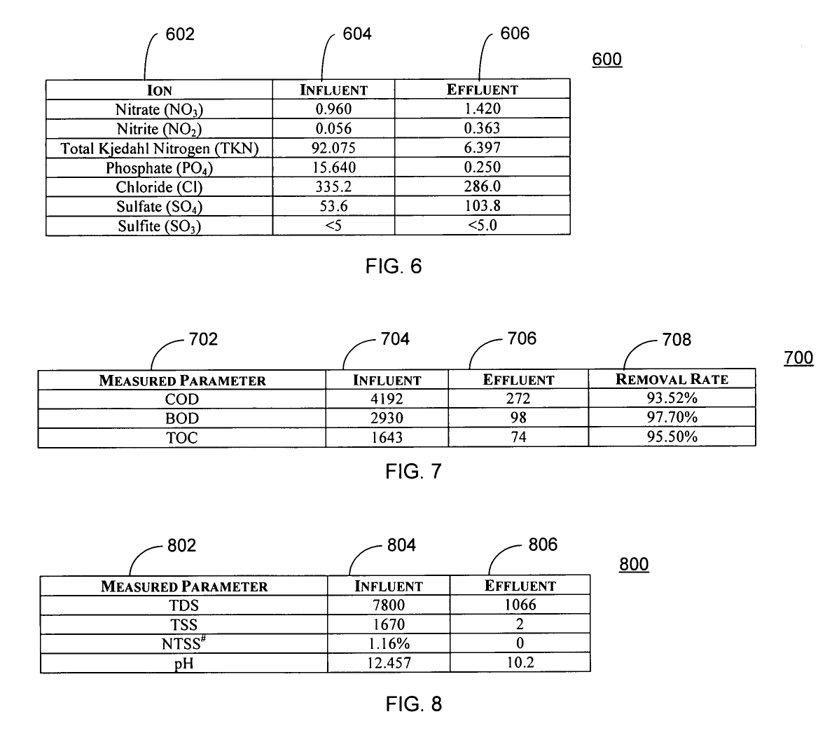

FIG. 6 is a table 600 storing recorded readings of particular ions in both the influent and the effluent of water treatment system 100. The first column 602 lists the ions that were tested for. The second column 604 lists the corresponding level of the particular ion (by row) as measured in the influent of the system. The third column 606 lists the corresponding level of the particular ion as measured in the effluent of the system. The recorded readings populating the table represent mean average values measured over a two week period.

FIG. 7 is a table 700 storing recorded readings of particular BOD, COD and TOC (total oxidizable (organic) carbon) as measured in both the influent and the effluent of water treatment system 100. The first column 702 lists the particular BOD, COD or TOC that was tested for. The second column 704 lists the corresponding level of the particular material as measured in the influent of the system. The third column 706 lists the corresponding level of the particular material as measured in the effluent of the system. Finally, the forth column 708 contains the corresponding removal rate percentage in the corresponding BOD, COD or TOC (by row) as recorded between the influent and effluent of the system. The recorded readings populating the table represent mean average values measured over a two week period.

FIG. 8 is a table 800 storing recorded readings of particular TDS, TSS, NTSS (natural total soluble solids) and pH as measured in both the influent and the effluent of water treatment system 100. The first column 802 lists the TDS, TSS, NTSS and pH that was tested for. The second column 804 lists the corresponding level of the particular material as measured in the influent of the system. The third column 806 lists the corresponding level of the particular material as measured in the effluent of the system. The recorded readings populating the table represent mean average values measured over a two week period.

The invention is not limited to the particular details of the apparatus shown or described and other modifications and applications may be contemplated. One or more steps may be combined into a single step while a single step may be expanded into multiple steps. In addition, the order of the steps may be altered. Certain other changes may be made in the above-described apparatus without departing from the true spirit and scope of the invention herein involved. It is intended, therefore, that the subject matter of the above depiction shall be interpreted as illustrative and not any limiting sense.

What is claimed is:

1. A process of removing suspended and dissolved material from fruit and vegetable wastewater comprising the steps of:
adding a coagulant polymer to the wastewater creating a charge interaction wherein coagulated solid particles are formed from the suspended and dissolved material in the wastewater;
adding a synthetic organic polymer having a known molecular size and weight to the wastewater to neutralize the coagulated solid particles into solid particles having a specific definable and controllable size and weight; and
filtering from the wastewater the solid particles having a specific definable and controllable size and weight.

2. The process as recited in claim 1, wherein the coagulant polymer is selected from the group including: an aluminum compound having a charge of +3, an iron based compound having a charge of +3 and a calcium compound.

3. The process as recited in claim 2, wherein the aluminum based compound is selected from the group including: aluminum chloride, aluminum sulfide, poly aluminum chloride and aluminum chlorohydrate.

4. The process as recited in claim 2, wherein the iron based compound is selected from the group including: ferric sulfate and ferric chloride.

5. The process as recited in claim 1, wherein the coagulant polymer is added in an amount that is based upon quantity of TSS, BOD and COD in the wastewater.

6. The process as recited in claim 1, wherein the coagulant polymer is added in an amount that is approximately equal to: 20*((BOD Qty+COD Qty+(0.35*(TSS Qty)))/1000), wherein the BOD Qty, COD Qty and TSS Qty represent the corresponding amounts of BOD, COD and TSS in the wastewater.

7. The process as recited in claim 1, wherein the coagulant polymer is a basic coagulant polymer when the pH of the wastewater is low and is an acidic coagulant polymer when the pH of the wastewater is high.

8. The process as recited in claim 1, wherein coagulant polymer is added in an amount between 50 to 200 ppm.

9. The process as recited in claim 1, wherein the synthetic organic polymer is a controlled mole weight cation.

10. The process as recited in claim 1, wherein the synthetic organic polymer is selected from the group including: DADMAC, acrylamide and epi-dma.

11. The process as recited in claim 1, wherein the synthetic organic polymer is epi-dma having a low molecular weight.

12. The process as recited in claim 1, wherein the synthetic organic polymer is an organic polymeric backbone of known molecular size and weight.

13. The process as recited in claim 1, wherein the synthetic organic polymer is added in an amount between a 5:1 and 25:1 ratio of coagulant polymer to synthetic organic polymer.

14. The process as recited in claim 1, wherein the synthetic organic polymer is added in an amount between 10 to 50 ppm.

15. The process as recited in claim 1, wherein the coagulant and synthetic organic polymers have a dwell time that is sufficient for the formation of solid particles having a relative tight distribution of solid particle size.

16. The process as recited in claim 15, wherein the dwell time is between 5 and 30 minutes.

17. The process as recited in claim 1, wherein the filtering is performed by a polypropylene filter membrane.

18. The process as recited in claim 17, wherein the wastewater flows through the filter membrane from the outside of the filter membrane to the inside of the filter membrane.

19. The process as recited in claim 1, further comprising the step of adding a pH adjuster to the wastewater to adjust the pH of wastewater and to remove sulfates.

20. The process as recited in claim 19, wherein the pH adjuster is Mg(O).

21. A process of removing suspended and dissolved material from fruit and vegetable wastewater comprising the steps of:
adding an amount of a coagulant polymer to the wastewater creating a charge interaction wherein coagulated solid particles are formed from the suspended and dissolved material in the wastewater, wherein the amount of coagulated polymer added is approximately equal to: 20*((BOD Qty+COD Qty+(0.35*(TSS Qty)))/1000), where the BOD Qty, COD Qty and TSS Qty represent the corresponding amounts of BOD, COD and TSS in the wastewater;
adding an amount of a synthetic organic polymer having a known molecular size and weight to the wastewater to neutralize the coagulated solid particles into solid particles having a specific definable and controllable size and weight, wherein the amount of synthetic organic polymer added is between a 5:1 and 25:1 ratio of coagulant polymer to synthetic organic polymer; and
filtering from the wastewater the solid particles having a specific definable and controllable size and weight.

22. The process as recited in claim 21, wherein the coagulant polymer is selected from the following group of compounds: an aluminum based compound having a charge of +3, an iron compound having a charge of +3, and a calcium compound.

23. The process as recited in claim 21, wherein the synthetic organic polymer is selected from the following group of compounds: DADMAC, acrylamide and epi-dma.

24. A process of removing suspended and dissolved material from a continuous stream of fruit and vegetable wastewater comprising the steps of:
adding coagulant and synthetic organic polymers to the continuous stream of wastewater producing a continuous stream of treated solution containing treated liquid and solid particles having a specific definable and controllable size and weight;
separating the solid particles and treated liquid from the continuous stream of treated solution by using a settling process and producing a continuous stream of treated liquid; and
filtering the continuous stream of treated liquid through a filter membrane resulting in the collection of residual solid particles and a continuous stream of filtered liquid.

25. The process as recited in claim 24, wherein the coagulant polymer is selected from the following group of compounds: an aluminum based compound having a charge of +3, an iron compound having a charge of +3 and a calcium compound.

26. The process as recited in claim 24, wherein the synthetic organic polymer is selected from the following group of compounds: DADMAC, acrylamide and epi-dma.

27. The process as recited in claim 24, wherein the step of adding coagulant and synthetic organic polymers has a dwell time between 5 and 30 minutes.

28. The process as recited in claim 24, wherein the continuous stream of wastewater has a flow rate and the continuous stream treated solution has a flow rate and the two flow rates are equal.

29. The process as recited in claim 24, wherein the continuous stream of wastewater has a flow rate and the continuous stream treated liquid has a flow rate and the two flow rates are equal.

30. The process as recited in claim 24, wherein the residual solid particles collected on the filter membrane act as a separate filter that filters out other residual solid particles and as the residual solid particles accumulate on the filter membrane a fluid flow through the filter membrane is not significantly reduced.

31. The process as recited in claim 24, wherein the wastewater flows through the filter membrane from the outside of the filter membrane to the inside of the filter membrane.

32. A process of removing suspended and dissolved material from a continuous stream of fruit and vegetable wastewater comprising the steps of:
adding coagulant and synthetic organic polymers to the continuous stream of wastewater producing a continuous stream of treated solution containing treated liquid and solid particles having a specific definable and controllable size and weight, wherein the coagulant polymer is selected from the following group of compounds: an aluminum based compound having a charge of +3, an iron compound having a charge of +3, and a calcium compound;
separating the solid particles and treated liquid from the continuous stream of treated solution by using a settling process and producing a continuous stream of treated liquid, wherein the synthetic organic polymer is selected from the following group of compounds: DADMAC, acrylamide and epi-dma; and
filtering the continuous stream of treated liquid through a filter membrane resulting in the collection of residual solid particles and a continuous stream of filtered liquid, wherein the residual solid particles collected on the filter membrane act as a separate filter that filters out other residual solid particles and as the residual solid particles accumulate on the filter membrane a fluid flow through the filter membrane is not significantly reduced.

33. The process as recited in claim 32, wherein the step of adding coagulant and synthetic organic polymers has a dwell time between 5 and 30 minutes.

34. The process as recited in claim 32, wherein the continuous stream of wastewater has a flow rate and the continuous stream treated liquid has a flow rate and the two flow rates are equal.

35. A product for consumption by animals wherein the product is rendered from solid particles having a specific definable and controllable size and weight, and wherein the solid particles are generated from a process that removes suspended and dissolved material in fruit and vegetable wastewater using coagulant and synthetic organic polymers.
